(19) United States
(12) Patent Application Publication
(10) Pub. No.: US 2015/0230194 A1
(43) Pub. Date: Aug. 13, 2015

(54) UPLINK TIMING ADJUSTMENT FOR WIRELESS COMMUNICATION

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/176,596

(22) Filed: Feb. 10, 2014

(51) Int. Cl. H04W 56/00; H04W 74/00; H04W 72/04; H04L 5/00

(52) U.S. Cl. CPC H04W 56/0045; H04L 5/0051; H04W 74/006; H04W 72/0446

(57) ABSTRACT

A user equipment (UE) applies an uplink timing adjustment during a high speed data call to allow uplink transmission of different UEs to arrive at a base station at a particular estimated time. In one instance, the UE determines whether a downlink (DL) timing varies more than a predetermined amount within a specified time period. The UE applies a timing advance command received in response to a scheduling request when the timing varies more than the predetermined amount. The UE also ignores a current uplink timing based on a closed loop timing advance command

### BACKGROUND

1. Field

Aspects of the present disclosure relate generally to wireless communication systems, and more particularly, to adjusting uplink timing in a high speed data network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes determining whether a downlink (DL) timing varies more than a predetermined amount within a specified time period. The method also includes applying a timing advance command received in response to a scheduling request when the timing varies more than the predetermined amount, and ignoring a current uplink timing based on a closed loop timing advance command.

According to another aspect of the present disclosure, an apparatus for wireless communication includes means for determining whether a downlink (DL) timing varies more than a predetermined amount within a specified time period. The apparatus also includes means for applying a timing advance command received in response to a scheduling request when the timing varies more than the predetermined amount, and ignoring a current uplink timing based on a closed loop timing advance command.

According to one aspect of the present disclosure, an apparatus for wireless communication includes a memory and a processor(s) coupled to the memory. The processor(s) is configured to determine whether a downlink (DL) timing varies more than a predetermined amount within a specified time period. The processor(s) is also configured to apply a timing advance command received in response to a scheduling request when the timing varies more than the predetermined amount, and ignoring a current uplink timing based on a closed loop timing advance command.

According to one aspect of the present disclosure, a computer program product for wireless communication in a wireless network includes a computer readable medium having non-transitory program code recorded thereon. The program code includes program code to determine whether a downlink (DL) timing varies more than a predetermined amount within a specified time period. The program code also includes program code to apply a timing advance command received in response to a scheduling request when the timing varies more than the predetermined amount, and ignoring a current uplink timing based on a closed loop timing advance command.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a call flow diagram according to one aspect of the present disclosure.

FIG. 5 is a block diagram illustrating a method for adjusting uplink timing according to one aspect of the present disclosure.

FIG. 6 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

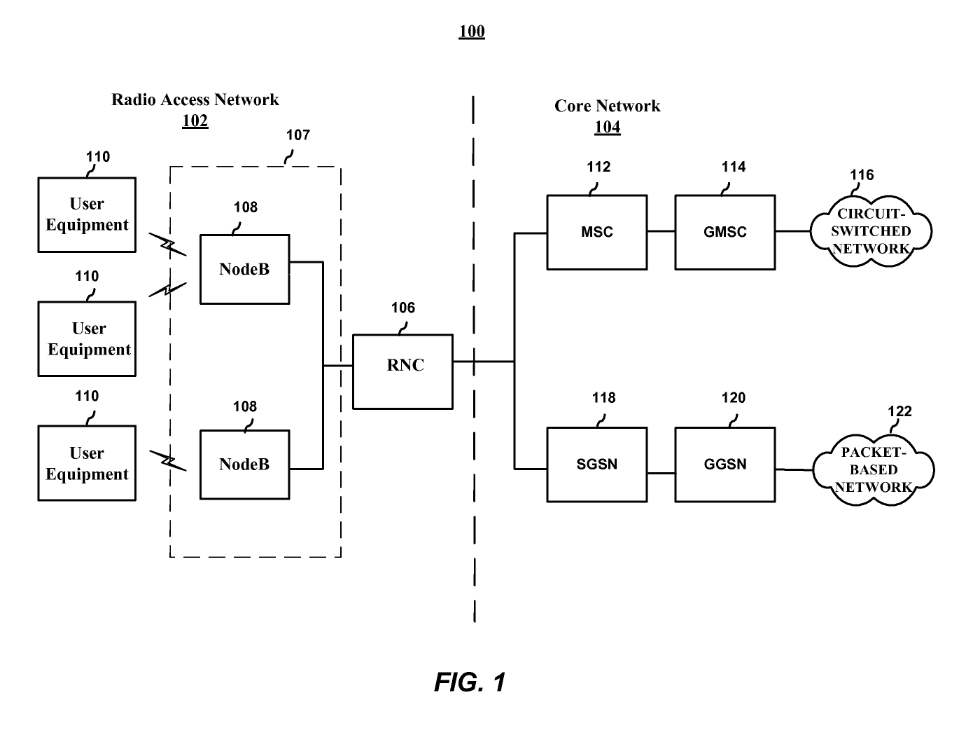

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

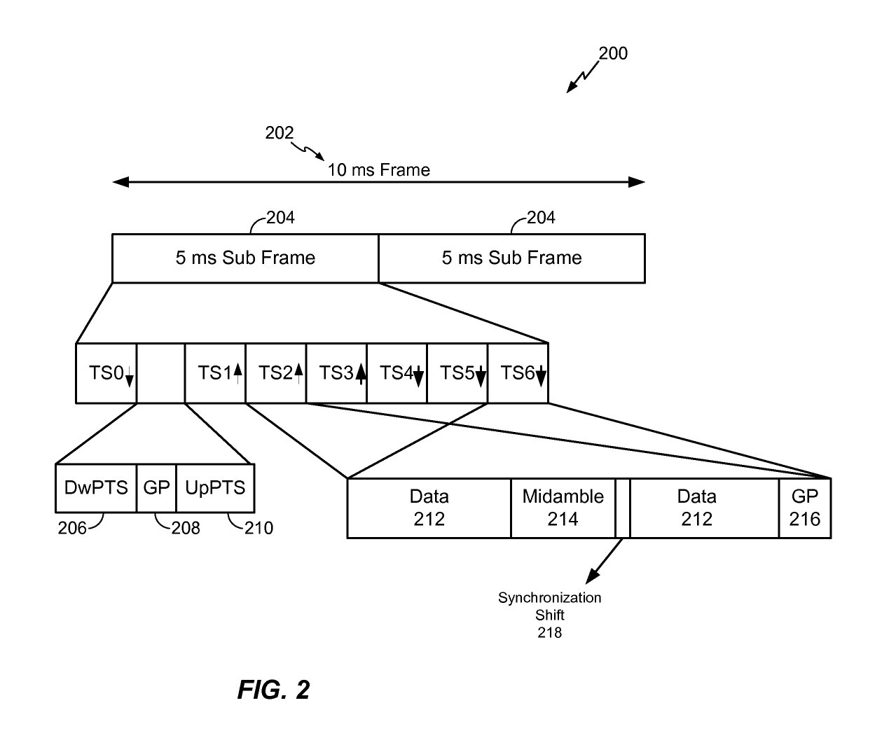

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

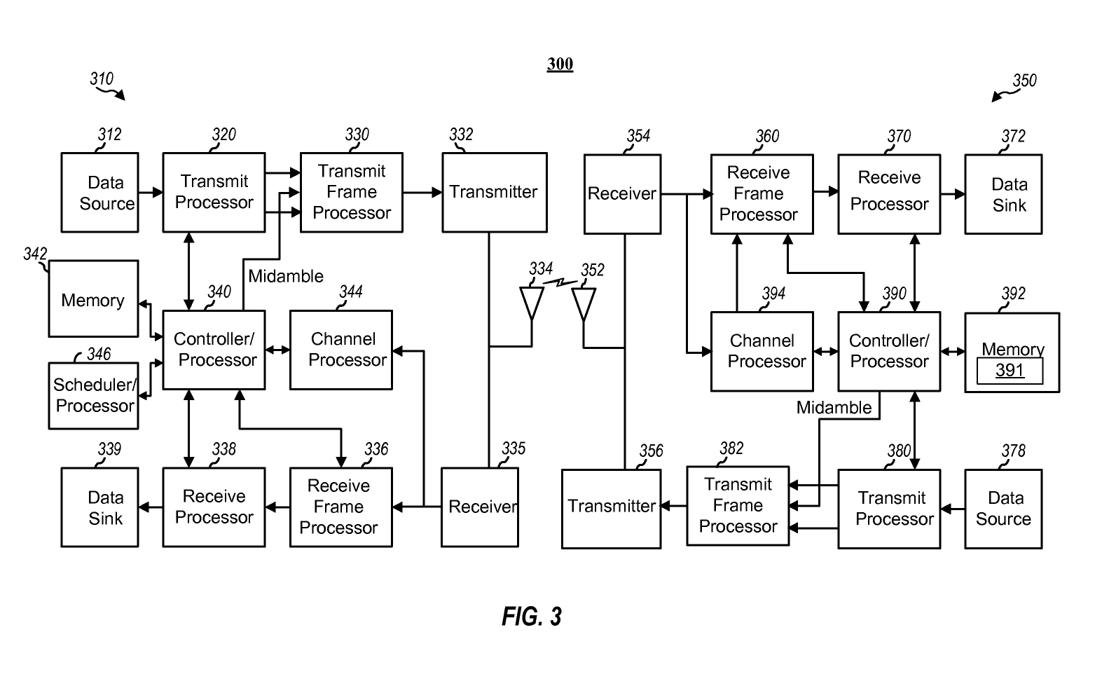

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a timing module 391 which, when executed by the controller/processor 390, configures the UE 350 for adjusting uplink transmission timing.

High speed uplink packet access (HSUPA) or time division high speed uplink packet access (TD-HSUPA) is a set of enhancements to time division synchronous code division multiple access (TD-SCDMA) in order to improve uplink throughput. In TD-HSUPA, the following physical channels are relevant.

The enhanced uplink dedicated channel (E-DCH) is a dedicated transport channel that features enhancements to an existing dedicated transport channel carrying data traffic.

The enhanced data channel (E-DCH) or enhanced physical uplink channel (E-PUCH) carries E-DCH traffic and schedule information (SI). Information in this E-PUCH channel can be transmitted in a burst fashion.

The E-DCH uplink control channel (E-UCCH) carries layer 1 (or physical layer) information for E-DCH transmissions. The transport block size may be 6 bits and the retransmission sequence number (RSN) may be 2 bits. Also, the hybrid automatic repeat request (HARQ) process ID may be 2 bits.

The E-DCH random access uplink control channel (E-RUCCH) is an uplink physical control channel that carries SI and enhanced radio network temporary identities (E-RNTI) for identifying UEs.

The absolute grant channel for E-DCH (enhanced access grant channel (E-AGCH)) carries grants for E-PUCH transmission, such as the maximum allowable E-PUCH transmission power, time slots, and code channels.

The hybrid automatic repeat request (hybrid ARQ or HARQ) indication channel for E-DCH (E-HICH) carries HARQ ACK/NAK signals.

The operation of TD-HSUPA may also have the following steps. First, in the resource request step, the UE sends requests (e.g., via scheduling information (SI)) via the E-PUCH or the E-RUCCH to a base station (e.g., Node B). The requests are for permission to transmit on the uplink channels. Next, in a resource allocation step, the base station, which controls the uplink radio resources, allocates resources. Resources are allocated in terms of scheduling grants (SGs) to individual UEs based on their requests. In the third step (i.e., the UE Transmission step), the UE transmits on the uplink channels after receiving grants from the base station. The UE determines the transmission rate and the corresponding transport format combination (TFC) based on the received grants. The UE may also request additional grants if it has more data to transmit. Finally, in the fourth step (i.e., the base station reception step), a hybrid automatic repeat request (hybrid ARQ or HARQ) process is employed for the rapid retransmission of erroneously received data packets between the UE and the base station.

The transmission of SI (scheduling information) may consist of two types in TD-HSUPA: (1) In-band and (2) Out-band. For in-band, which may be included in MAC-e PDU (medium access control e-type protocol data unit) on the E-PUCH, data can be sent standalone or may piggyback on a data packet. For Out-band, data may be sent on the E-RUCCH in case that the UE does not have a grant. Otherwise, the grant expires.

The scheduling information (SI) may include the following information or fields: the highest priority logical channel ID (HLID) field, the total E-DCH buffer status (TEBS) field, the highest priority logical channel buffer status (HLBS) field and the UE power headroom (UPH) field.

The highest priority logical channel ID (HLID) field unambiguously identifies the highest priority logical channel with available data. If multiple logical channels exist with the highest priority, the one corresponding to the highest buffer occupancy will be reported.

The total E-DCH buffer status (TEBS) field identifies the total amount of data available across all logical channels for which reporting has been requested by the radio resource control (RRC) and indicates the amount of data in number of bytes that is available for transmission and retransmission in the radio link control (RLC) layer. When the medium access control (MAC) is connected to an acknowledged mode (AM) RLC entity, control protocol data units (PDUs) to be transmitted and RLC PDUs outside the RLC transmission window are also be included in the TEBS. RLC PDUs that have been transmitted but not negatively acknowledged by the peer entity shall not be included in the TEBS. The actual value of TEBS transmitted is one of 31 values that are mapped to a range of number of bytes (e.g., 5 mapping to TEBS, where 24<TEBS<32).

The highest priority logical channel buffer status (HLBS) field indicates the amount of data available from the logical channel identified by HLID, relative to the highest value of the buffer size reported by TEBS. In one configuration, this report is made when the reported TEBS index is not 31, and relative to 50,000 bytes when the reported TEBS index is 31. The values taken by HLBS are one of a set of 16 values that map to a range of percentage values (e.g., 2 maps to 6%<HLBS<8%).

The UE power headroom (UPH) field indicates the ratio of the maximum UE transmission power and the corresponding dedicated physical control channel (DPCCH) code power.

The serving neighbor path loss (SNPL) reports the path loss ratio between the serving cells and the neighboring cells. The base station scheduler incorporates the SNPL for inter-cell interference management tasks to avoid neighbor cell overload.

### Adjusting Uplink Timing

Different UEs may be separated by code channels within a data time period. Each UE helps maintain the separation by adjusting its uplink transmission timing so that all of the UE uplink transmissions arrive at the Node B at a particular estimated timing. Once received, the Node B may then perform various actions. For example, the Node B may de-spread and separate the received signal(s) from the different UE(s). The Node B may estimate the timing by evaluating the channel impulse response of the UEs.

In each uplink timeslot, the midamble for each UE is different. The Node B measures the midamble and in the next available downlink timeslot, the Node B signals a synchronization shift (SS) command to instruct the UE to properly adjust its transmission (Tx) timing with respect to the timing of the received downlink. In particular with regards to the uplink timing, the synchronization shift (SS) bits can instruct the UE to advance the timing, delay the timing, or to keep the timing constant. The Node B continuously measures the timing of the UE and sends the appropriate synchronization shift (SS) commands in each subframe. The UE adjusts the timing based on the SS commands carried on the downlink signal. The UE derives a single SS command separately for each controlled uplink timeslot by combining the received SS commands within the last “M” subframes, and then adjusts the uplink timing every M subframes. The value of the “uplink synchronization frequency” M is statically configured by the network. When the combined SS command is judged as ‘down,’ the UE transmit timing is delayed by a step of k/8 chips. When the command is judged as ‘up,’ the UE transmit timing is advanced by a step of k/8 chips. When the command is judged as ‘do nothing,’ the timing is remains constant and is not changed. The value of the “uplink synchronization step size” k is configured by higher layers.

The SS command is carried on one modulation symbol and has a chance of being mis-detected. The UE derives a single SS command by combining all received SS commands within the last M subframes, and adjusts the uplink timing every M subframes. This “SS average method” can improve the uplink closed loop adjustment performance via a small adjustment step size. For some scenarios, such as fast timing variation due to high mobility or UE location change, the small adjustment step size may be too slow to adapt to fast timing variation in an efficient manner.

When the UE is in a dedicated channel (DCH) state, the uplink channels share the same uplink transmission, or have a time slot offset if the uplink channels are on different uplink time slots. Accordingly, the uplink channels from the same or different UEs are separated by a code channel. In order for the Node B to de-spread and separate the uplink channels, the arrival timing of the uplink transmissions should be aligned. Various aspects of the present disclosure are directed to uplink timing adjustments in a high speed data network.

The UE uses the E-RUCCH random access procedure to send scheduling requests to the Node B in a TD-HSUPA call. The E-RUCCH random access procedure is similar to the RACH random access procedure. For example, the available eight uplink synchronization sequence/code (SYNC_UL) signatures in a cell are divided into two subsets (e.g., one set for PRACH and the other set for E-RUCCH).

When a Node B detects a SYNC UL signature and acknowledges it on the related fast physical access channel (FPACH), some recordings are made to assist the Node B in identifying the access type for decoding. The recording includes the FPACH channel number, the sub-frame on which the acknowledgement is sent, and the SYNC_uplink signature number. When a PRACH or E-RUCCH comes from a UE, the Node B derives the related FPACH and the sub-frame on which the acknowledgement was sent for the UE and locates the right record. The record may indicate the access type, (e.g., PRACH or E-RUCCH) to the Node B.

In one example procedure, the UE estimates the uplink timing and sends a SYNC-UL sequence designated for E-RUCCH in sub-frame n. If the Node B can detect the SYNC-UL sequence, the Node B measures the SYNC-UL sequence to derive an arrival timing advance (e.g., uplink physical channel position (UpPCHPOS)). The Node B sends the timing advance (e.g., UpPCHPOS) in the FPACH, typically within a designated number of subframes (e.g., 4 subframes) if there is an FPACH resource. The UE then computes the E-RUCCH timing, e.g., T_{TX E-RUCCU}), using the timing advance (e.g., UpPCHPOS). This closed loop type of timing adjustment utilizes small step size adjustments which can be ineffective when there is a large timing variation.

One aspect of the present disclosure is directed to applying an uplink timing adjustment during a high speed data call. In particular, when a small timing variation is observed, a received timing advance is ignored. Alternately, when a large timing variation is observed, the timing advance carried on an FPACH and received in response to a schedule request may be applied to adjust the uplink timing.

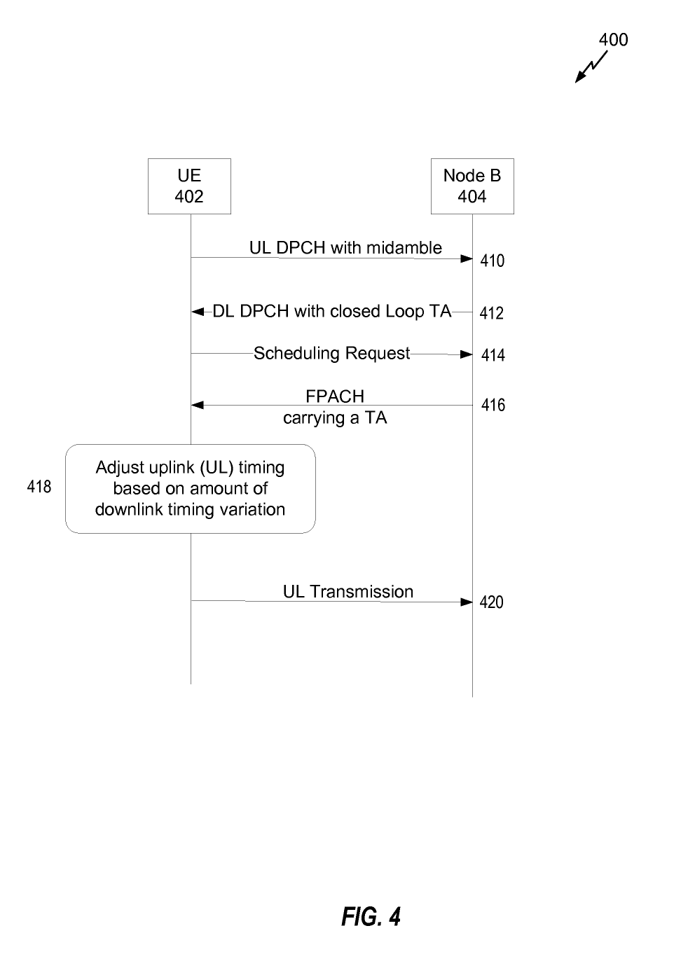

FIG. 4 is a call flow diagram illustrating an uplink timing adjustment. During a TD-HSUPA call, at time 410, the node B 404 receives a transmission (e.g., uplink dedicated physical channel (UL DPCH)) from the UE 402. The Node B 404 measures the midamble from the received transmission and determines the synchronization shift (SS) command. At time 412 the UE receives a downlink dedicated physical channel (DPCH) including a closed loop timing advance (TA) command based on the measured midamble.

At time 414 the UE 402 sends a scheduling request (SR). For example, a SYNC-UL sequence designated for E-RUCCH is transmitted. At time 416, the UE 402 receives an FPACH carrying a timing advance (TA) command in response to the scheduling request.

At time 416, the UE determines whether a timing variation exceeds a predetermined value (or threshold). In particular, the UE determines whether a measured downlink path loss and/or downlink timing variation (observed within a predefined time window) exceeds a threshold value. When the timing variation is above a predefined threshold, the UE applies the timing advance carried in the FPACH to the uplink transmission sent at time 418. Otherwise, the UE ignores the timing advance command carried in the FPACH, and instead applies the timing advance (SS command) associated with the uplink DPCH to the uplink transmission timing at time 418. That is, the UE transmits at time 420 based on the closed loop timing adjustment.

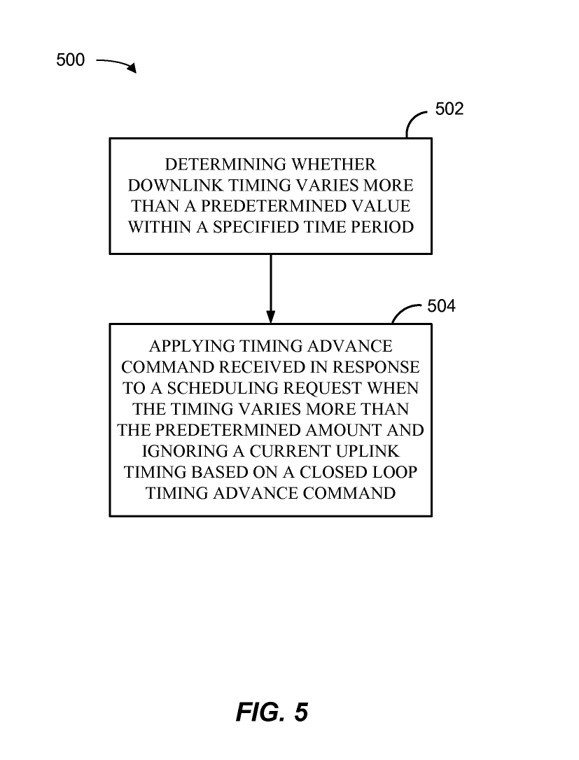

FIG. 5 shows a wireless communication method 500 according to one aspect of the disclosure. In block 502, a UE determines whether a downlink timing varies more than a predetermined amount during a specified time period. The specified time period and the predetermined amount may be adjusted based on channel quality, speed of a user equipment (UE), Doppler frequency and/or mobility status (i.e., high, low or medium) of the UE. The UE applies a timing advance command received in response to the scheduling request when the timing varies more than the predetermined amount. The UE then ignores a current uplink timing based on a closed loop timing advance command, as shown in block 504.

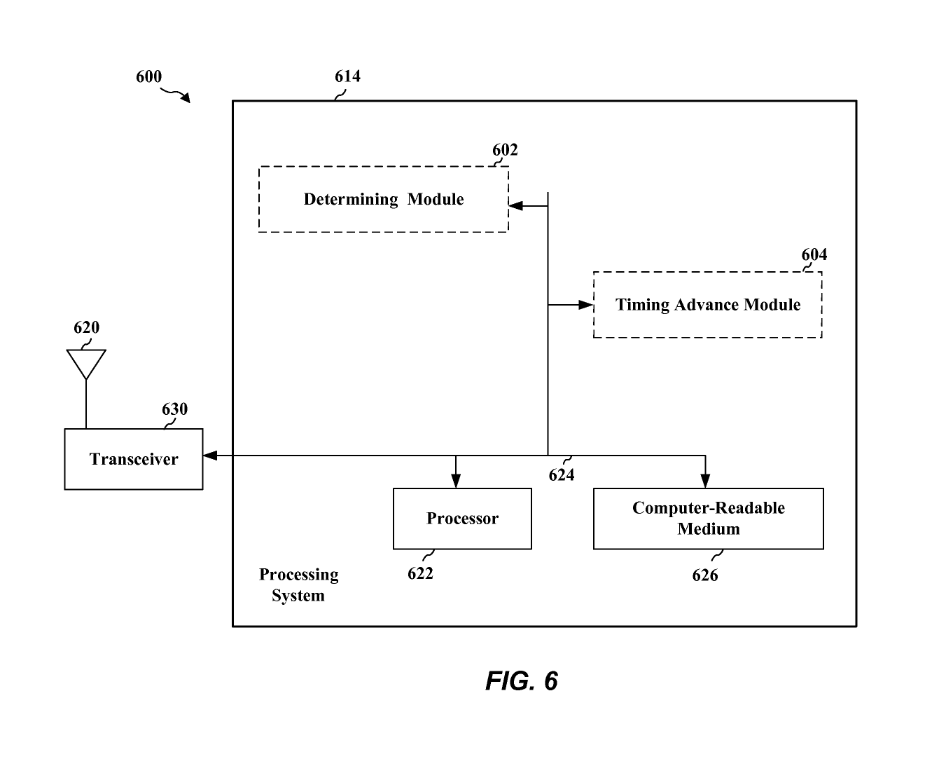

FIG. 6 is a diagram illustrating an example of a hardware implementation for an apparatus 600 employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware modules, represented by the processor 622 the modules 602, 604, and the non-transitory computer-readable medium 626. The bus 624 may also link various other circuits such as timing sources, peripherals, voltage regulators, and power management circuits, which are well known in the art, and therefore, will not be described any further.

The apparatus includes a processing system 614 coupled to a transceiver 630. The transceiver 630 is coupled to one or more antennas 620. The transceiver 630 enables communicating with various other apparatus over a transmission medium. The processing system 614 includes a processor 622 coupled to a non-transitory computer-readable medium 626. The processor 622 is responsible for general processing, including the execution of software stored on the computer-readable medium 626. The software, when executed by the processor 622, causes the processing system 614 to perform the various functions described for any particular apparatus. The computer-readable medium 626 may also be used for storing data that is manipulated by the processor 622 when executing software.

The processing system 614 includes a determining module 602 for determining whether a downlink timing varies more than predetermined amount within a specified time period. The processing system 614 includes a timing advance module 604 for applying a timing advance command received in response to a scheduling request when the timing varies more than the predetermined value. In this case, the timing advance module ignores a current uplink timing based on a closed loop timing advance command. The modules may be software modules running in the processor 622, resident/stored in the computer readable medium 626, one or more hardware modules coupled to the processor 622, or some combination thereof. The processing system 614 may be a component of the UE 350 and may include the memory 392, and/or the controller/processor 390.

In one configuration, an apparatus such as a UE is configured for wireless communication including means for determining. In one aspect, the determining means may be the controller/processor 390, the memory 392, the timing module 391, the determining module 602 and/or the processing system 614 configured to perform the determining. The UE is also configured to include means for applying a timing advance command. In one aspect, the applying means may be the controller/processor 390, the memory 392, timing module 391, timing advance module 604 and/or the processing system 614 configured to perform the applying. In one aspect the means functions recited by the aforementioned means. In another aspect, the aforementioned means may be a module or any apparatus configured to perform the functions recited by the aforementioned means.

Several aspects of a telecommunications system has been presented with reference to TD-HSUPA. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining whether a downlink (DL) timing varies more than a predetermined amount within a specified time period; and
applying a timing advance command received in response to a scheduling request when the timing varies more than the predetermined amount, and ignoring a current uplink timing based at least in part on a closed loop timing advance command.

2. The method of claim 1, further comprising ignoring the timing advance command received in response to the scheduling request when the timing varies less than the predetermined amount.

3. The method of claim 1, in which the scheduling request includes an uplink synchronization (SYNC) sequence for an enhanced dedicated channel random access uplink control channel (ERUCCH).

4. The method of claim 1, in which the timing advance command is an absolute timing advance command received in a fast physical access channel (FPACH).

5. The method of claim 1, in which the specified time period is about four (4) seconds in duration.

6. The method of claim 1, further comprising adjusting the specified time period based at least in part on channel quality, user equipment (UE) speed, Doppler frequency and/or mobility status of the UE.

7. The method of claim 1, further comprising adjusting the predetermined amount based at least in part on channel quality, speed of a user equipment (UE), Doppler frequency and/or mobility status of the UE.

8. An apparatus for wireless communication, comprising:
means for determining whether a downlink (DL) timing varies more than a predetermined amount within a specified time period; and
means for applying a timing advance command received in response to a scheduling request when the timing varies more than the predetermined amount, and ignoring a current uplink timing based at least in part on a closed loop timing advance command.

9. The apparatus of claim 8, further comprising means for ignoring the timing advance command received in response to the scheduling request when the timing varies less than the predetermined amount.

10. The apparatus of claim 8, in which the scheduling request includes an uplink synchronization (SYNC) sequence for an enhanced dedicated channel random access uplink control channel (ERUCCH).

11. An apparatus for wireless communication, comprising:
a memory; and
at least one processor coupled to the memory and configured:
to determine whether a downlink (DL) timing varies more than a predetermined amount within a specified time period; and
to apply a timing advance command received in response to a scheduling request when the timing varies more than the predetermined amount, and ignoring a current uplink timing based at least in part on a closed loop timing advance command.

12. The apparatus of claim 11, in which the at least one processor is further configured to ignore the timing advance command received in response to the scheduling request when the timing varies less than the predetermined amount.

13. The apparatus of claim 11, in which the scheduling request includes an uplink synchronization (SYNC) sequence for an enhanced dedicated channel random access uplink control channel (ERUCCH).

14. The apparatus of claim 11, in which the timing advance command is an absolute timing advance command received in a fast physical access channel (FPACH).

15. The apparatus of claim 11, in which the specified time period is about four (4) seconds in duration.

16. The apparatus of claim 11, in which the at least one processor is further configured to adjust the specified time period based at least in part on channel quality, speed of a user equipment (UE), Doppler frequency and/or mobility status of the UE.

17. The apparatus of claim 11, in which the at least one processor is further configured to adjust the predetermined amount based at least in part on channel quality, speed of a user equipment (UE), Doppler frequency and/or mobility status of the UE.

18. A computer program product for wireless communication in a wireless network, comprising:
a non-transitory computer-readable medium having program code recorded thereon, the program code comprising:
program code to determine whether a downlink (DL) timing varies more than a predetermined amount within a specified time period; and
program code to apply a timing advance command received in response to a scheduling request when the timing varies more than the predetermined amount, and ignoring a current uplink timing based on a closed loop timing advance command.

19. The computer program product of claim 18, in which the program code further comprises program code to ignore the timing advance command received in response to the scheduling request when the timing varies less than the predetermined amount.

20. The computer program product of claim 18, in which the scheduling request includes an uplink synchronization (SYNC) sequence for an enhanced dedicated channel random access uplink control channel (ERUCCH).
